(19) United States
(12) Patent Application Publication
(10) Pub. No.: US 2007/0095218 A1
(43) Pub. Date: May 3, 2007

(54) POLE MARKING SYSTEM FOR IMPROVED MANUFACTURING PROCESS

(75) Inventor: Andrew Strange, Collierville, TN (US)

Correspondence Address: HOFFMAN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 11/554,625

(22) Filed: Oct. 31, 2006

Related U.S. Application Data
(60) Provisional application No. 60/732,360, filed on Oct. 31, 2005.

(51) Int. Cl. B41F 17/00

(52) U.S. Cl. 101/35

(57) ABSTRACT

The invention relates to an assembly for marking a pole transported by a conveyor, including a support frame located adjacent at least a portion of the conveyer. The assembly also includes at least one print head assembly for marking the pole. The at least one print head assembly includes at least one print head. Also the at least one print head is moveably secured to the frame and selectively maintains biased engagement with the pole.

### CROSS-REFERENCE TO RELATED APPLICATIONS

This application claims the benefit of U.S. Provisional Patent Application Ser. No. 60/732,360 filed on Oct. 31, 2005.

### BACKGROUND OF THE INVENTION

The present invention is directed to an assembly and system for use in manufacturing utility poles. More particularly, to an assembly and system for marking utility poles during the manufacturing process in order to locate and orient hardware and other features to be attached to the poles upon installation.

Large steel utility poles are commonly used to support power and/or data transmission lines. For example, such poles are often used as part of an electric grid for routing high voltage wires from a power generator source. Generally, these poles have hardware that is fastened to them after they have been erected and installed on-sight. Thus markings need to be added in the appropriate location along the pole to position and orient features which will be permanently installed. Such features include climbing ladder clips, grounding nuts, hangers for insulator brackets, e.g., for wire routing, screws, plates, and so on. Also, alphanumeric markings are generally needed to identify the corresponding part number to be mounted, as well as appropriately sized symbols and dimensions, for example, to identify part, size, shape and orientation of mounting hardware and components.

A typical system and method for marking these steel structures includes having an on-sight layout operator either climb the pole or use some type of mechanical lifter. Once in position, the operator will manually draw and/or mark the layout of the desired hardware on an outer wall of the pole. The operator will have at his or her disposal the fabrication drawings corresponding to the utility pole, and a tape measure. After reviewing the drawings, the operator uses the tape measure to mark the location for attaching the specified components and to indicate their respective orientations on the utility pole in accordance with the fabrication drawings. The operator then usually tack welds the corresponding components to the utility pole in preparation for permanent attachment of the hardware for installation. The process is time consuming, tedious, and extremely subject to human error.

Thus, it is desirable to provide a utility pole marking apparatus, system and/or method which overcomes the shortcomings found in the art of utility pole installation as set forth above while also providing an efficient and automated marking system to facilitate the manufacturing process of metal, particularly steel, utility poles.

### SUMMARY OF THE INVENTION

The invention relates to an assembly for marking a pole transported by a conveyor including a support frame located adjacent at least a portion of the conveyer. The assembly also includes at least one print head assembly for marking the pole. The at least one print head assembly includes at least one print head. Also, the at least one print head is moveably secured to the frame for selectively engaging the pole.

Additionally, the above mentioned assembly can alternatively include a plurality of print head assemblies. Each of the print head assemblies can be located to selectively engage a predetermined portion of the pole. Also, the at least one print head can maintain engagement with the pole as the pole is transported by the conveyor. The engagement can be maintained over a portion of the pole having a longitudinally changing outer circumference. Further, the at least one print head assembly can further include at least one actuator for translating a print head relative to the pole. The translation occurring radially, longitudinally and/or circumferentially relative to the pole. Further still, the at least one print head assembly can include a sensor for maintaining the selective engagement by detecting the relative positions of the pole and the at least one print head. Yet further still, the assembly can further include a data processor for controlling the coordinate position of the at least one print head based on a model of the pole. Yet further still, the at least one print head assembly can further include at least one wheel assembly for reducing frictional engagement between the assembly and the pole. Also, each of the print head assemblies can be capable of printing onto a predetermined portion of the pole. Such that, the print head assemblies compensate for variable pole diameters, through an overlapping coverage of the predetermined portions. Additionally, the at least one print head assembly can include a plurality of print heads disposed on a planar carriage.

The present invention also relates to a system for marking a utility pole for field installation of fixtures thereon. The system includes a plurality of print head assemblies, a frame, a data processor and an actuator control module. Each of the print head assemblies includes at least one print head for marking the pole and an actuator assembly for changing the position of the print head assemblies relative to the pole. The frame supports the print head assemblies. The data processor assembly controls the changes of position of the print head assemblies. The actuator control module is coupled to at least one of the actuators and communicates with the processor for activating the at least one actuator to effect the changes of position.

Additionally, the above mentioned data processor assembly can translate data from a three-dimensional model of the pole, including pre-selected marking locations on the model, into commands transmitted to at least one of the actuator controls for positioning at least one print head. Once so positioned the print head can affix a mark on the pole in a position analogous to at least one of the pre-selected marking locations. Also, the actuator assembly can selectively engage the print head with the pole. The engagement can be maintained over a variable width portion of the pole. Further, each of the print head assemblies is capable of printing onto a predetermined portion of the pole. Further still, the system can further include at least one sensor for selectively maintaining engagement of at least one print head with the pole. This is performed at least in part by detecting the relative positions of the pole and the at least one print head. Yet further still, at least one of the plurality of print head assemblies can further include at least one wheel assembly for reducing frictional engagement between the assembly and the pole.

The present invention further relates to a method of marking a utility pole for field installation of fixtures thereon. The method includes the steps of providing a conveyor for carrying said utility pole. Also a plurality of print head assemblies is provided. The print head assemblies are located to selectively engage a predetermined portion of the pole. Further, each of the print head assemblies includes at least one print head for marking the pole and an actuator assembly for changing the position of the print head assembly relative to the pole. The method also includes activating the print head assemblies to selectively engage the pole. Further, the method includes initiating at least one print head to leave a mark on the pole. The mark provides a reference for installation of the fixtures on the pole.

Further, the above mentioned method can have the step of initiating at least one print head controlled by an automated system. Also, the engagement can be maintained at least in part through print head positioning translated from a three-dimensional model of the pole.

These and other objectives, features, and advantages of this invention will become apparent from the following detailed description of illustrative embodiments thereof, which is to be read in connection with the accompanying drawings

### BRIEF DESCRIPTION OF THE DRAWINGS

FIG. 1 is a perspective drawing of an embodiment of a system for pole-marking formed in accordance with the present invention.

FIG. 2 is a magnified view of FIG. 1, showing a print head assembly of the embodiment of the system.

FIG. 3 is a perspective drawing of a portion of another embodiment of a system formed in accordance with the present invention.

FIG. 4 is a block diagram of an embodiment of a system formed in accordance with the present invention.

FIG. 5 is a front view of another embodiment of an assembly and system for pole-marking in accordance with the present invention.

FIG. 6 is a front view of yet another embodiment of an assembly and system for pole-marking in accordance with the present invention.

### DETAILED DESCRIPTION OF THE INVENTION

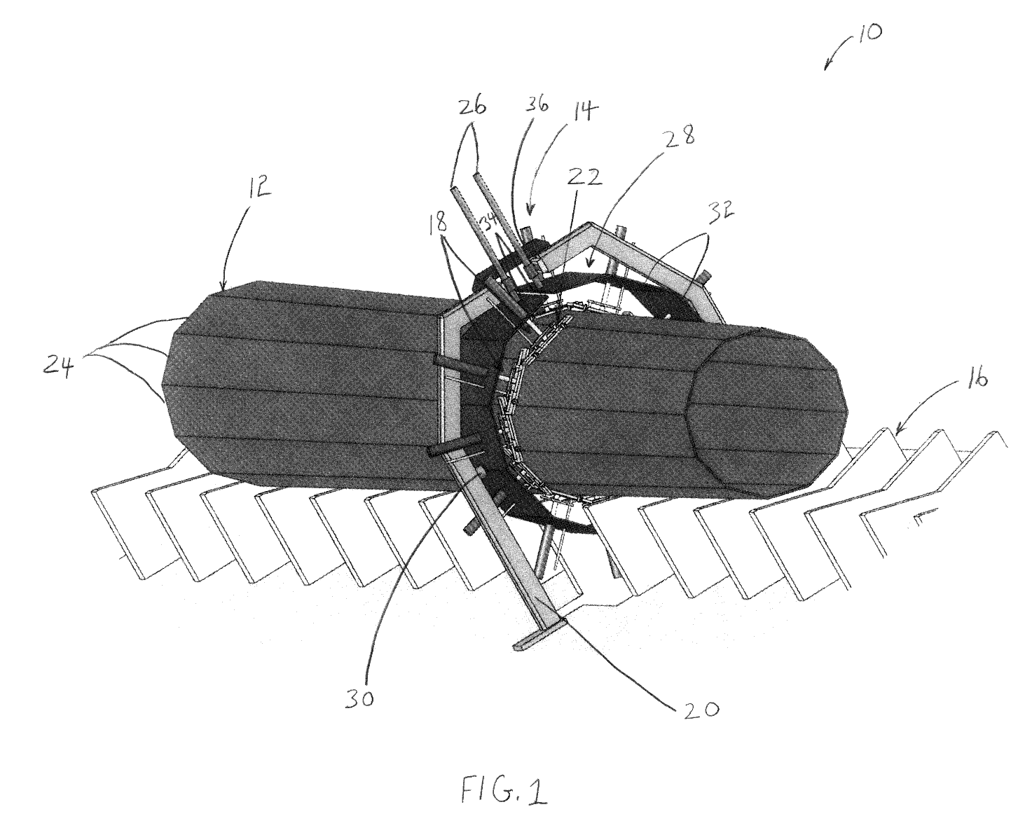

As shown in FIG 1, a system 10 for marking a steel pole or structure 12 according to the present invention includes a marking device 14 and a transfer or conveyor belt 16. The marking or printing device 14 includes a plurality of print head assemblies 18 and a frame 20 to which the plurality of print head assemblies 18 are operatively mounted.

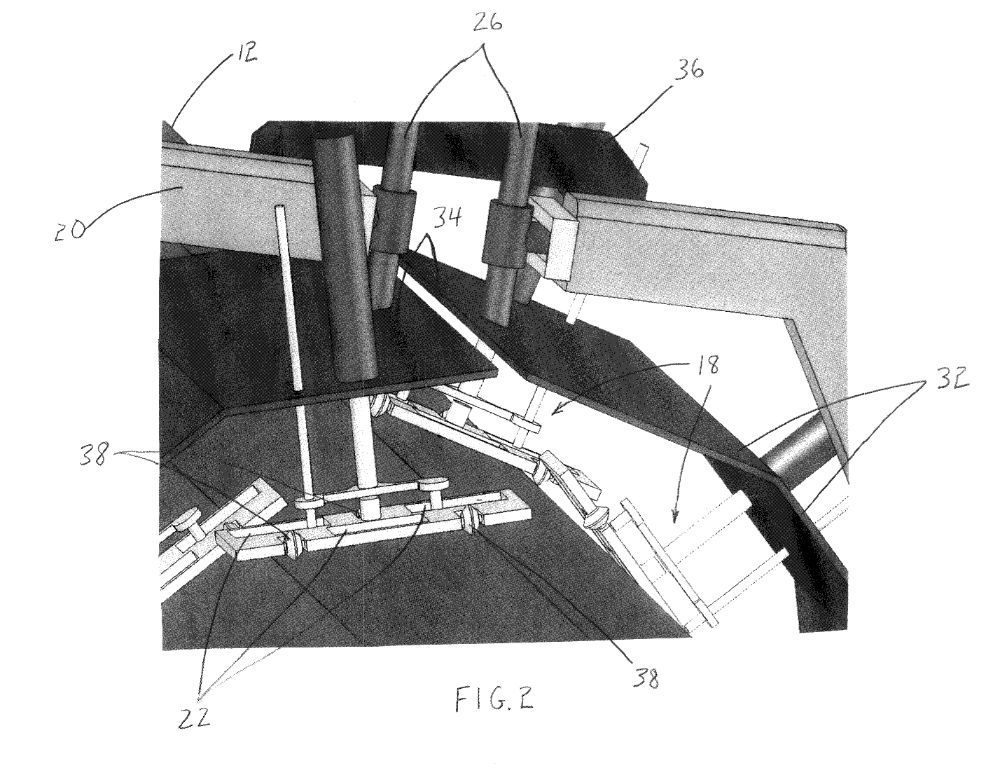

Referring also to FIG. 2, each print head assembly 18 includes at least one print head 22 for marking the pole 12. Individual print heads 22 (three are included on each assembly 18 as shown in FIGS. 1 and 2) must ride close to, preferably in contact with, the surface of a particular section of the pole 12 as the pole 12 passes through the printing device 14 via the transfer belt 16.

The system 10 shown in FIGS. 1-2 accommodates a common type and shape of utility pole. As shown, the pole 12 is hollow and tapered, to form a light-weight yet structurally sound utility pole 12 upon installation, with the wider end cemented into the ground. The pole 12 shown includes multiple flat sections or panels 24, rather than a continuous circular cross-section. The dodecagonal pole 12 shown can be formed by bending an appropriately shaped and sized single flat sheet of metal multiple times to form the panels 24. The ends of the multiple paneled structure are then rolled together to form the pole 12. The ends, as well as the seams connecting each panel are then welded together, preferably by moving the pole 12 past a welding device (not shown) on the conveyor belt 16. Either the welding device or the pole 12 can also be rotated on the belt 16 for access to all the seams, according to methods well-known to those skilled in the art.

A preferred style of steel transmission pole on which the subject invention operates is the multi-paneled pole 12 shown in FIGS. 1-2. Tubular poles with a circular cross-section , which are also usually tapered, may also be used. Typical diameters of these utility poles range from an outer diameter of about nine inches to about fifty inches and typical heights of the poles may range from about forty-seven feet to about sixty feet.

To affix the markings, the system 10 of the present invention uses the marking device 14 to print the necessary identifying markings preferably while the pole 12 is being welded and moved down the transfer belt 16. Because the pole 12 may be tapered, as the pole 12 passes through the device 14, the plurality of print head assemblies 18 must be free to move up and down to maintain substantially constant pressure and contact with the surface of the panels 24. Therefore, the device 14 preferably includes at least one vertical linear positioning device 26 to maintain constant contact of the print heads 22 with the panels 24 along the full length of the pole 12.

One skilled in the art will recognize that a closed loop control system may be used, for example, to maintain a constant pressure and/or vertical positioning of the print heads 22 on the surfaces of the panels 24 by integrating sensors, such as encoders and/or pressure sensors into the print heads 22. An error signal from the sensor drives the vertical positioning device 14 to maintain constant contact with the panels 24.

The vertical positioning device 26 may include any device known to those skilled in the art which can be used to translate the print head assemblies 18, such as a linear screw-driven motor stage. In one embodiment of a printing device 14 for use with multi-paneled utility poles shown in FIGS. 1-2, the device 14 includes a floating frame 28 mounted to the main frame 20, preferably via two horizontally positioned mounting pins 30. The floating frame 28 includes individual mounting panels 32 corresponding to the panels 24 of the pole 12. The floating frame 28 does not, however, form a closed cylinder as the pole 12 does. A space is left between two end panels 34 to allow the diameter of the floating frame 28 to be adjusted.

The entire floating frame 28 is adjusted as the pole 12 passes through the marking device 14 to an appropriate circular diameter for which contact is achieved for all print heads 22. The diameter is altered by vertically translating the positioning device 26 as required, preferably using a closed loop system as described above. Preferably, a linear horizontal translational device 36 is also included, with mounting points fixed to the two end panels 34. The horizontal device 36 pulls the two end panels 34 together synchronously with the movement of the vertical positioning device 26 to alter the diameter of the floating frame 28 and maintain constant contact of each print head 22 with the corresponding panel 24.

As shown in FIGS. 1 and 2, as the diameter decreases due to the taper of the pole 12, adjacent print head assemblies 18 are preferably allowed to slightly overlap. As the diameter increases, adjacent print assemblies 18 overlap less and less. At the maximum diameter, adjacent print assemblies 18 are preferably only slightly overlapping.

Referring again to FIG. 2, each individual print head assembly 18 includes at least one print head 22, preferably a piezoelectric or thermal transfer inkjet print head, such as those used in digital flatbed printers known to those skilled in the art. The print head 22 may include any type of printing or marking device capable of printing or marking metal. Most preferably, the print head 22 is a piezoelectric digital inkjet print head.

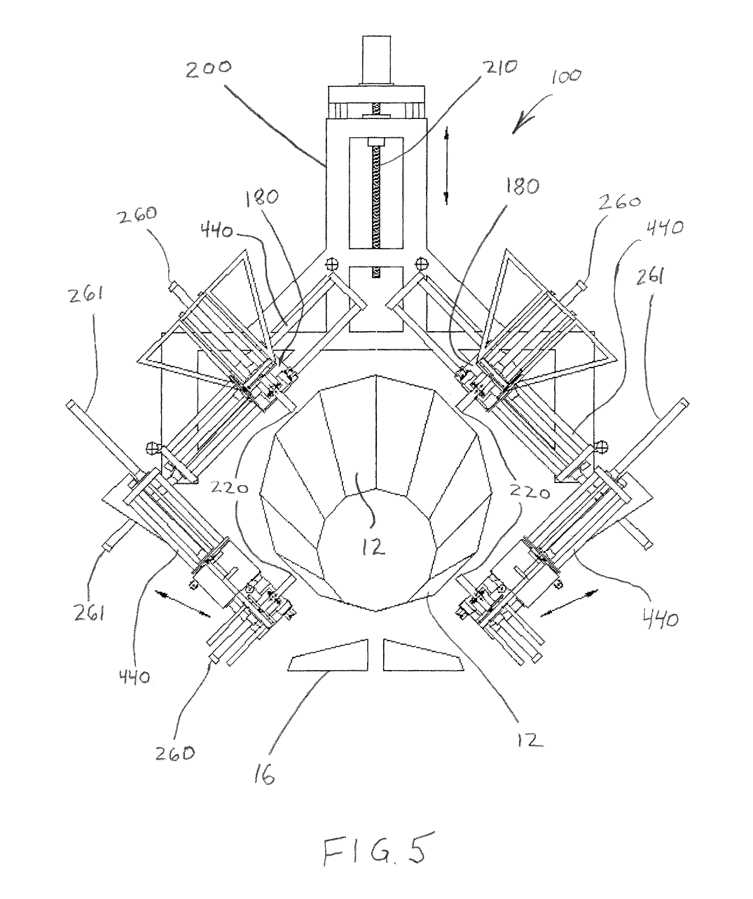

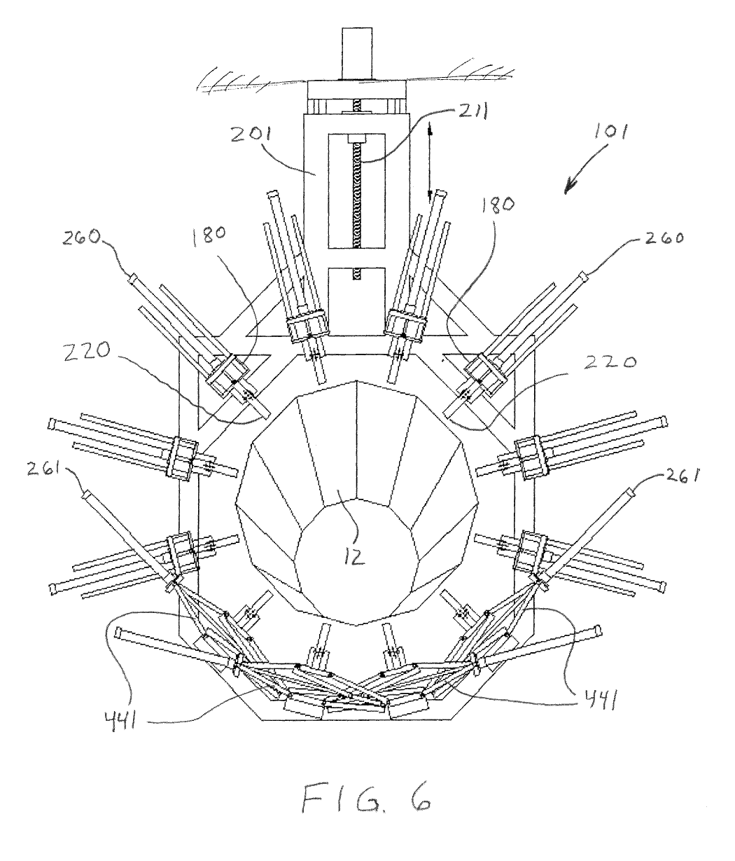

Each print head assembly 18 shown in the embodiment of FIGS. 1 and 2 includes three print heads 22, shown as slots in the figures, to cooperatively cover the entire extent of each panel 24 even at its widest end. Alternatively, as shown in FIGS. 5 and 6, one print head 220 may be used in each assembly which does not extend from one side of the panel to the other. In this case, an additional translational devices 440, 441, which may be either a linear or rotational device, are preferably added to allow each print head assembly to translate sideways and/or enable printing on virtually any portion of the pole 12.

Preferably, each print head assembly 18 also includes wheels 38, shown in FIG. 2 for maintaining smooth contact with the panel 24. The wheels 38 are preferably spring-loaded to accommodate small variations in the smoothness and flatness of the surface of each panel 24 while maintaining constant contact of the print heads 22 with the surface across the panel 24.

Though the apparatus and systems, 10, 100, 101 of FIGS. 1, 2, 5 and 6 are particularly suitable for marking paneled utility poles, one skilled in the art will recognize that they are readily adaptable to marking any structural strut, pole, beam, or other large structural element in need of such marking.

In one embodiment, for example, the system may be used to mark continuously cylindrical poles. In this embodiment, the contact surfaces of the print heads are could be curved rather than flat to match the curvature of the cylindrical pole. Alternatively, a larger number of closely spaced and substantially planar print heads may be used to assure reasonable contact with the surface of the cylindrical pole.

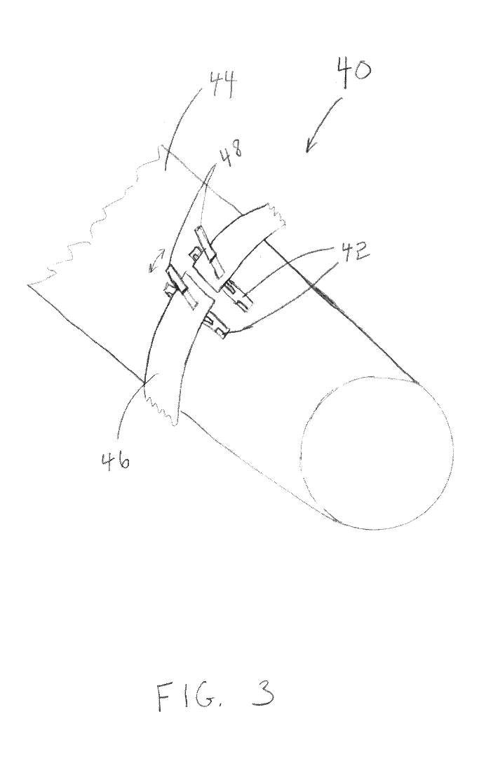

Referring to FIG. 3, an additional embodiment of a system 40 formed in accordance with the present invention includes substantially planar print head assemblies 42 such as those used in FIG. 1, but oriented along the length of, for example, a cylindrical pole 44 as shown. The assemblies 42 may be mounted in either one floating frame 46 as described above for adjusting the entire diameter of the frame 46, or positioned on independent panels or actuators and separately translated in the vertical direction as described above. The system 40 preferably further includes a rotational translational device 48 that allows enough rotational movement of the print heads from side to side to cover the entire surface area of the pole between the print heads. Though only two print head assemblies 42 are shown in FIG. 3, it is understood that the system 40 preferably includes a plurality of such print head assemblies 42 so that the entire circumference of the pole 44 is covered in analogy to FIG. 1.

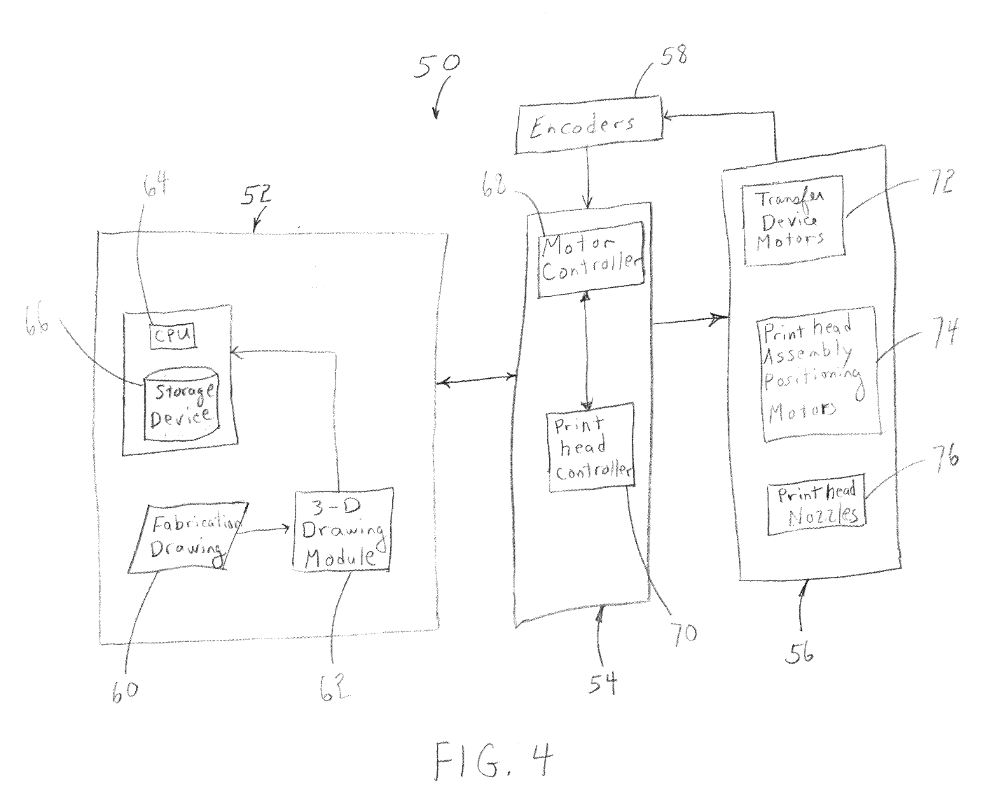

Referring to FIG. 4 as well as to FIG. 1, the system 10 formed in accordance with the present invention preferably additionally includes an automation control device 50 for automatically transferring markings from a fabrication drawing onto the pole 12 as it passes through the marking device 14. The automation control device 50 preferably includes a programmable interface module 52 for integrating the fabrication drawing into the pole manufacturing process, a device control module 54 and a device driver module 56. The device control module 54 tracks and relays positions of the pole 12 on the transfer device 16 and of the print head positions between the interface module 52 and the device driver module 56. Encoders 58 are preferably included to measure relative and/or absolute positions of the various motor in the system 10.

Referring still to FIG. 4, the programmable interface module 52 accepts the fabrication drawing 60 from a file or direct user input and preferably integrates the drawing 60 into a drawing module 62. Preferably, the drawing module 62 contains or generates a 3-drawing of the pole, for example, using a Computer Assisted Design (CAD) program, according to methods well-known to those skilled in the art. The drawing 60 with the markings to be printed is integrated into the CAD drawing for exact positioning of the markings on the pole 12 being manufactured. The programmable interface module 52 further includes a processing device 64 for processing positional information and a storage device 66 for storing files, particularly motor data files containing relative and absolute positioning information.

The control 54 includes a motor controller 68 which tracks and controls the various motor positions, and a print head controller 70 for operating the print heads, in accordance with input from the programmable interface 52. The controller 54 likewise triggers operation of the motor drivers operating the transfer motors 72 and print head assembly positioning motors 74. The device driver module 56, therefore, drives the motors and print head nozzles to the proper location for printing features according to the fabrication drawing. The print head nozzles 76 are consequently operated in accordance with instructions from the programmable interface 52 to transfer the features and markings from the fabrication drawing 60 to the pole 12.

Any of various motor controllers and drivers known to those skilled in the art may be used in the present invention, and integrated with the programmable interface 52 in accordance with methods well-known to those skilled in the art.

FIG. 5 shows another embodiment of the invention in the form of assembly 100. In this embodiment, the frame 200 supports only four print head assemblies 180. The frame 200, can be suspended from above the conveyor 16 and include a vertical lift mechanism 210, to retract the overall assembly 100. Also, rather than the panels 32 of the previous embodiment, the assembly 100 includes tracks 440 and tangential or circumferential translation devices 261, in addition to radial translation devices 260. Thus, the circumferential translation device, which is preferably a servo motor driven pneumatic cylinder, moves the print head assembly 180 across tracks 440. Also, it should be understood that further pivotally actuated joints could be provided for the tracks 440 or the print head assemblies 180 to enable printing on multiple sides of a pole, such as the dodecagonal pole 12 shown.

FIG. 6 shows yet another embodiment of the invention in the form of assembly 101. This embodiment once again uses one print head assembly for each planar side of the utility pole 12. However, in this embodiment none of the print head assemblies 180 are directly connected to adjacent print head assemblies 180. Rat her, they are each independently mounted on one frame 201. Frame 201 also preferably includes a vertical positioning device 211. Further, this embodiment does not employ a track assembly, but rather mounts the print head assemblies directly to the frame 201. Radial translation devices 260 are used on the upper print head assemblies 180. However, the lower print head assemblies 180 are provided radial translation through scissor jack mechanisms 441. Thus, actuation of translation device 260 either compresses or expands the scissor jack mechanism 441, providing radial translation. The scissor jack configuration is used for the lower assemblies in order to provide a lower profile for that part of the system near the ground. However, it should be understood that similar scissor jack configurations could be used for translation of all the print head assemblies 180.

A method according to the present invention, therefore, may include integrating either a three-dimensional computer-generated model of the pole assembly or an independently programmed model of the assembly with operation of a translation/transfer device and marking device of the present invention to accurately print the location, position, orientation, and part number of items to be attached.

In an additional embodiment of a method of the present invention, a template is printed of the fabrication drawing 60 on a flat, suitably sized and pliable material, such as a foil, which includes the correct location, position, orientation, and part number. The template is then positioned over and tacked onto the pole after the welding process, and the pole appropriately marked by spray painting, stenciling, or any other method known to those skilled in the art for transferring a design through a template onto a surface.

Therefore, a pole marking system formed in accordance with the present invention facilitates the manufacturing process of metal, particularly steel utility poles by providing an automated and efficient system.

One skilled in the art will further recognize that the system of the present invention may be modified to accommodate any structural or other similar component for automatically applying markings from a drawing to its surface.

While various embodiments of the present invention are specifically illustrated and/or described herein, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. An assembly for marking a pole transported by a conveyor, comprising:
a support frame located adjacent at least a portion of the conveyer; and
at least one print head assembly for marking the pole, the at least one print head assembly including at least one print head, and wherein the at least one print head is moveably secured to the frame for selectively engaging the pole.

2. The assembly of claim 1, wherein the at least one print head assembly includes a plurality of print head assemblies and each print head assemblies is located to selectively engage a predetermined portion of the pole.

3. The assembly of claim 1, wherein the at least one print head maintains engagement with the pole as the pole is transported by the conveyor.

4. The assembly of claim 3, wherein the engagement is maintained over a portion of the pole having a longitudinally changing outer circumference.

5. The assembly of claim 1, wherein the at least one print head assembly further includes at least one actuator for translating a print head relative to the pole, the translation occurring in at least one of a radial, a longitudinal and a circumferential direction of the at least one print head relative to the pole.

6. The assembly of claim 1, wherein the at least one print head assembly further includes a sensor for maintaining the selective engagement by detecting the relative positions of the pole and the at least one print head.

7. The assembly of claim 1, further comprising:
a data processor for controlling the coordinate position of the at least one print head based on a model of the pole.

8. The assembly of claim 1, wherein the at least one print head assembly further includes at least one wheel assembly for reducing frictional engagement between the assembly and the pole.

9. The assembly of claim 1, wherein the at least one print head assembly includes a plurality of print head assemblies, and each of the print head assemblies is capable of printing onto a predetermined portion of the pole, wherein the print head assemblies compensate for variable pole diameters, through an overlapping coverage of the predetermined portions.

10. The assembly of claim 1, wherein the at least one print head assembly includes a plurality of print heads disposed on a planar carriage.

11. A system for marking a utility pole for field installation of fixtures thereon, comprising:
a plurality of print head assemblies, wherein each of the print head assemblies includes at least one print head for marking the pole and an actuator assembly for changing the position of the print head assemblies relative to the pole;
a frame for supporting the print head assemblies;
a data processor assembly for controlling the changes of position of the print head assemblies; and
an actuator control module coupled to at least one of the actuators, the actuator control module communicating with the processor for activating the at least one actuator to effect the changes of position.

12. The system of claim 11, wherein the data processor assembly translates data from a three-dimensional model of the pole, including pre-selected marking locations on the model, into commands transmitted to at least one of the actuator controls for positioning at least one print head to affix a mark on the pole in a position analogous to at least one of the pre-selected marking locations.

13. The system of claim 11, wherein the actuator assembly selectively engages the print head with the pole.

14. The system of claim 13, wherein the engagement is maintained over a variable width portion of the pole.

15. The system of claim 11, wherein each of the print head assemblies is capable of printing onto a predetermined portion of the pole.

16. The system of claim 11, further comprising:
at least one sensor for selectively maintaining engagement of at least one print head with the pole by detecting the relative positions of the pole and the at least one print head.

17. The system of claim 11, wherein at least one of the plurality of print head assemblies further includes at least one wheel assembly for reducing frictional engagement between the assembly and the pole.

18. A method of marking a utility pole for field installation of fixtures thereon, comprising:
providing a conveyor for carrying said utility pole;
providing a plurality of print head assemblies, wherein each of the print head assemblies is located to selectively engage a predetermined portion of the pole, each of the print head assemblies including at least one print head for marking the pole and an actuator assembly for changing the position of the print head assembly relative to the pole;
activating the print head assemblies to selectively engage the pole; and
initiating at least one print head to leave a mark on the pole, the mark providing a reference for installation of the fixtures on the pole.

19. The method according to claim 18, wherein the step of initiating at least one print head is controlled by an automated system.

20. The method according to claim 18, wherein the engagement is maintained at least in part through print head positioning translated from a three-dimensional model of the pole.
